(19) United States
(12) Patent Application Publication
(10) Pub. No.: US 2026/0085654 A1
(43) Pub. Date: Mar. 26, 2026

(54) VERTICAL AXIS WIND TURBINE GUIDE AND ASSOCIATED SYSTEM AND METHOD

(71) Applicant: Youngstown State University, Youngstown, OH (US)

(72) Inventors: Stefan Ilie Moldovan, Cuyahoga Falls, OH (US); Aydin Ulus, Youngstown, OH (US)

(21) Appl. No.: 19/335,588

(22) Filed: Sep. 22, 2025

Related U.S. Application Data
(60) Provisional application No. 63/696,881, filed on Sep. 20, 2024.

(51) Int. Cl. F03D 3/00

(52) U.S. Cl. CPC F03D 3/005; F05B 2240/12; F05B 2240/9113

(57) ABSTRACT

A system for utilizing wind generated by vehicles includes a vertical axis wind turbine and a plurality of guides configured to guide wind to the vertical axis wind turbine. The plurality of wind guides are aligned along a vehicle trajectory to capture more of the generated winds even after the vehicle has passed the turbine.

This application claims the benefit of U.S. Provisional Application No. 63/696,881 filed Sep. 20, 2024, the contents of which are incorporated by reference herein.

### BACKGROUND

The present exemplary embodiment relates to vertical axis wind turbine guides, systems for generating electricity and/or hydrogen utilizing a vertical axis wind turbine and guide system, and methods using the systems for generating electricity and/or hydrogen.

Vertical axis wind turbines (VAWTs) are modern devices crafted to harness wind power and transform it into electricity. Unlike the classic horizontal axis wind turbines (HAWTs) with blades spinning around a horizontal axis, VAWTs feature blades rotating around a vertical axis, akin to a large eggbeater or spinning top.

The operational principle of a VAWT is based around the interaction between its blades and the wind. When the wind blows, it exerts a force on the blades, prompting them to spin around the central vertical axis. This rotational movement propels a generator or alternator positioned at the turbine's base, converting mechanical energy into electrical power. VAWTs are versatile, capable of generating electricity from winds blowing in all directions, making them suitable for various environments.

Various types of VAWTs exist, each with distinct designs and operational attributes. For instance, Savonius turbines feature curved blades that capture wind energy through drag, making them apt for low wind speeds. Conversely, Darrieus turbines use airfoil-shaped blades to generate lift forces, enabling efficient operation at higher wind speeds. Additionally, helical, giromill, and cycloturbine designs offer alternative options, each with its own set of advantages in efficiency, scalability, and environmental impact.

Highway VAWTs are specially crafted for deployment alongside highways and roads, offering a promising pathway for renewable energy production. These turbines exploit the consistent wind flow generated by passing vehicles, leveraging strategically positioned guide vanes or deflectors to amplify energy capture. By tapping into the kinetic energy of passing traffic, highway VAWTs provide a unique opportunity to generate clean, sustainable electricity while minimizing the environmental impact associated with conventional energy sources.

It would be desirable to develop new vertical axis wind turbine guides, systems, and methods, particularly for generating electricity and/or hydrogen (e.g., near highways).

### BRIEF DESCRIPTION

The present disclosure relates to systems and methods for utilizing wind generated by vehicles.

Disclosed, in some embodiments, is a system for utilizing wind generated by vehicles. The system includes a vertical axis wind turbine and a plurality of guides configured to guide wind to the vertical axis wind turbine. The plurality of wind guides are aligned along a vehicle trajectory to capture more of the generated winds even after the vehicle has passed the turbine.

Disclosed, in other embodiments, is a method for utilizing wind generated by vehicles. The method includes passing vehicles through the aforementioned system.

These and other non-limiting characteristics are more particularly described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following is a brief description of the drawings, which are presented for the purposes of illustrating the exemplary embodiments disclosed herein and not for the purposes of limiting the same.

FIG. 1 illustrates 2D computational domain (CD) for an elliptical vertical axis wind turbine (VAWT) on a highway with a car. For the area is the rectangle, finer structure mesh was used for CD analysis.

FIG. 2 illustrates geometric dimensions of a car (left) and a bus (right).

FIG. 3 illustrates geometric parameters of an elliptical-type VAWT.

FIG. 4 illustrates geometric parameters of a highway VAWT using two guides.

FIG. 5 illustrates geometric parameters of a highway VAWT using three guides.

FIG. 6 illustrates 2D boundary conditions for an elliptical VAWT on a highway with a car. For the area is the rectangle, finer structure mesh was used for CD analysis.

FIG. 7 illustrates details of the computational mesh for a three-guide system on a highway using a car.

FIG. 8 illustrates power generation for a car over flow time for unguided, two guide, and three guide embodiments.

FIG. 9 illustrates power generation for a bus over flow time for unguided, two guide, and three guide embodiments.

FIG. 10 illustrates power generation for a car (detail) over flow time for unguided, two guide, and three guide embodiments.

FIG. 11 illustrates power versus car distance from the VAWT.

FIG. 12 illustrates power versus bus distance from the VAWT.

FIG. 13 illustrates power generation for a bus (detail) over flow time for unguided, two guide, and three guide embodiments.

FIG. 14 illustrates velocity distribution for a car for a VAWT for non-guided (left) and three-guides (right) configurations.

FIG. 15 illustrates velocity vectors for a car for non-guided (left) and three-guides (right) configurations.

FIG. 16 illustrates velocity distribution for a car for a VAWT for non-guided (left) and three-guides (right) configurations.

FIG. 17 illustrates velocity vectors for a car for non-guided (left) and three-guides (right) configurations.

FIG. 18 illustrates velocity distribution for a car for a VAWT for non-guided (left) and three-guides (right) configurations.

FIG. 19 illustrates velocity vectors for a car for non-guided (left) and three-guides (right) configurations.

FIG. 20 illustrates velocity distribution for a bus for a VAWT for non-guided (left) and three-guides (right) configurations.

FIG. 21 illustrates velocity vectors for a bus for non-guided (left) and three-guides (right) configurations.

FIG. 22 illustrates velocity distribution for a bus for a VAWT for non-guided (left) and three-guides (right) configurations.

FIG. 23 illustrates velocity vectors for a bus for non-guided (left) and three-guides (right) configurations.

FIG. 24 illustrates velocity distribution for a bus for a VAWT for non-guided (left) and three-guides (right) configurations.

FIG. 25 illustrates velocity vectors for a bus for non-guided (left) and three-guides (right) configurations.

FIG. 26 illustrates non-limiting examples of guide designs.

FIG. 27 is a chart including parameters for two guides.

FIG. 28 is a chart including parameters for three guides.

FIG. 29 is a chart providing boundary conditions.

FIG. 30 is a chart providing mesh quality stats.

FIG. 31 is a chart providing grid convergence information.

FIG. 32 is a chart providing the solver set-up.

FIG. 33 is a chart for energy and improvement information for no guide, two guides, and three guides for a single car on a highway.

FIG. 34 is a chart for energy and improvement information for no guide and three guides for a single bus on a highway.

### DETAILED DESCRIPTION

The present disclosure may be understood more readily by reference to the following detailed description of desired embodiments included therein, the drawings. In the following specification and the claims which follow, reference will be made to a number of terms which shall be defined to have the following meanings.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent can be used in practice or testing of the present disclosure. All publications, patent applications, patents, and other references mentioned herein are incorporated by reference in their entirety. The materials, methods, and articles disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases that require the presence of the named ingredients/steps and permit the presence of other ingredients/steps. However, such description should be construed as also describing compositions, mixtures, or processes as “consisting of” and “consisting essentially of” the enumerated ingredients/steps, which allows the presence of only the named ingredients/steps, along with any impurities that might result therefrom, and excludes other ingredients/steps.

Unless indicated to the contrary, the numerical values in the specification should be understood to include numerical values which are the same when reduced to the same number of significant figures and numerical values which differ from the stated value by less than the experimental error of the conventional measurement technique of the type used to determine the particular value.

All ranges disclosed herein are inclusive of the recited endpoint and independently combinable (for example, the range of “from 2 to 10” is inclusive of the endpoints, 2 and 10, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

An article by the present inventors is included as an appendix to the present application and is incorporated by reference herein in its entirety-“optimization of Vertical Axis Wind Turbine Systems to Capture Vehicle-Induced Highway Winds,” Aydin Ulus and Stefan Ilie Moldovan, Energies 2025, 18, 3139.

The present disclosure relates to systems and methods for utilizing wind generated by vehicles. The systems include a vertical axis wind turbine and a plurality of guides configured to guide wind to the vertical axis wind turbine. The plurality of wind guides are aligned along a vehicle trajectory to capture more of the generated winds even after the vehicle has passed the turbine.

The guides of the present disclosure may be made from metals, metal alloys, and/or composites.

Non-limiting examples of metals include aluminum and titanium.

Non-limiting examples of metal alloys include steel, aluminum alloys, and titanium alloys.

Non-limiting examples of composites include fiberglass and carbon fiber.

In some embodiments, the height of the guides is the same as the height of the turbine. Non-limiting examples of turbine blade height to guide height include 0.75 to 1.25, 0.80 to 1.20, 0.85 to 1.15, 0.90 to 1.10, and 0.95 to 1.05.

The shape of the guides may be constant or varied throughout their height.

The height of each guide may be independently designed.

Including a guide in combination with a vertical axis wind turbine design can significantly improve its overall efficiency. Non-limiting examples of beneficial effects include:
increased power output: curved/angled guide(s) upstream if rotor blades redirects airflow by channeling wind towards the advancing blades. The increased wind flow causes the advancing blades to experience greater aerodynamics forces, resulting in a stronger rotational force on the turbine, ultimately leading to higher electricity generation;
reduced drag: vertical axis win turbines inherently experience draft on the returning blades as they move against the wind direction. A guide can help mitigate this drag by strategically blocking or diverting a portion of the wind away from the returning blades. This reduction in resistance faced by the returning blades allows the advancing blades to have a more pronounced effect, contributing to smoother overall rotation; and
improved torque coefficient: the turbine's rotational force, or net torque, results from the dynamic interplay between the positive torque generated by advancing blades and the counteracting torque generated by returning blades. Guides play a crucial role in optimizing the turbine's torque profile. By minimizing drag during low-efficiency blade rotations and maximizing thrust during power-generating cycles, they effectively enhance the overall torque coefficient. This translates to increased efficiency in extracting energy from the wind resource.
While guides offering promising efficiency improvements, several factors must be considered. The design and positioning of the guides is important. A poorly designed guide may cause turbulence or disrupt the airflow, potentially negating the intended benefits. Additionally, the guides strength and stability must be sufficient to withstand wind loads without compromising the turbine's structural integrity.

In highway applications, vertical axis wind turbines may offer benefits such as:
generation of clean energy that can be used to power highway lights, signs, and other infrastructure;
reduced greenhouse gas emissions to mitigate climate change by generating clean energy and displacing fossil fuel reliance;
energy independence from fossil fuels and their associated environmental impact;
creation of new jobs and stimulation of economic growth; and
acting as a sound barrier.

The wind turbine blades may be elliptical blades. Elliptical blade are more aerodynamically efficient compared to semicircular Savonius blades. Elliptical blades can generate higher lift forces and lower drag forces, which translates to better energy conversion. Curved, airfoil-shaped elliptical blades more efficiently convert wind energy into rotational motion.

With reference to the Figures, the following table describes a non-limiting list of potential parameters. The radiuses, for example, may be adjusted based on the size of the turbine diameter.

The systems of the present application generally utilize using guides curved towards incoming traffic and arranged circumferentially at different locations to guide more of passing winds into the turbine.

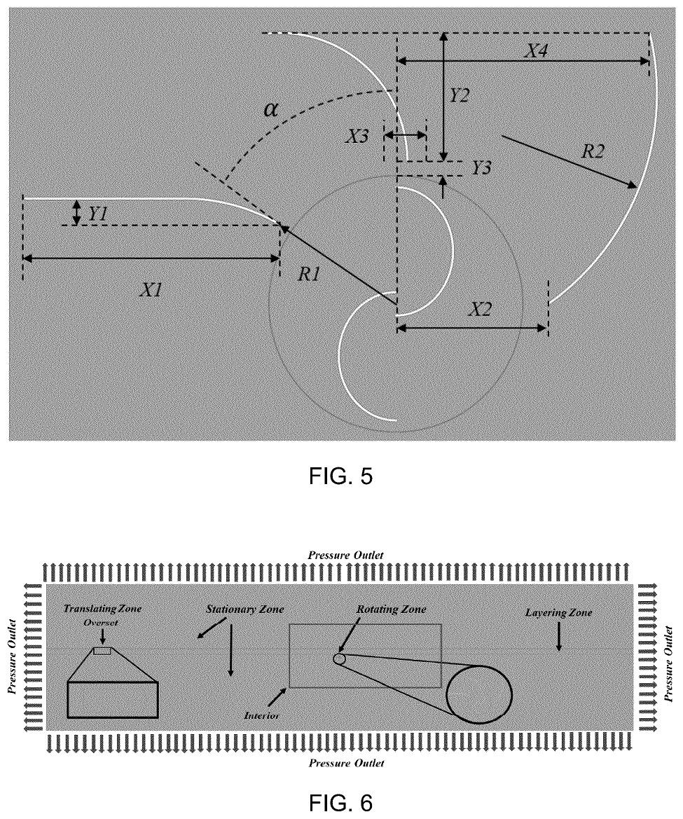

In some embodiments, a limiting geometric parameter is the imaginary top horizontal line marked by Y2+Y3 (FIG. 5) since that can dictate how close the entire installation will be to passing traffic. This is why both guide 2 and guide 3 end at that top location.

Horizontally, there is a location of diminishing returns where the guides will start adding too much friction and thus the wind will not be helpful.

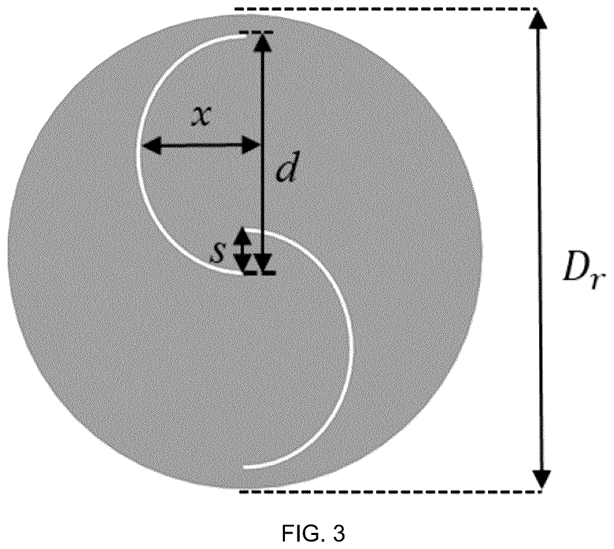

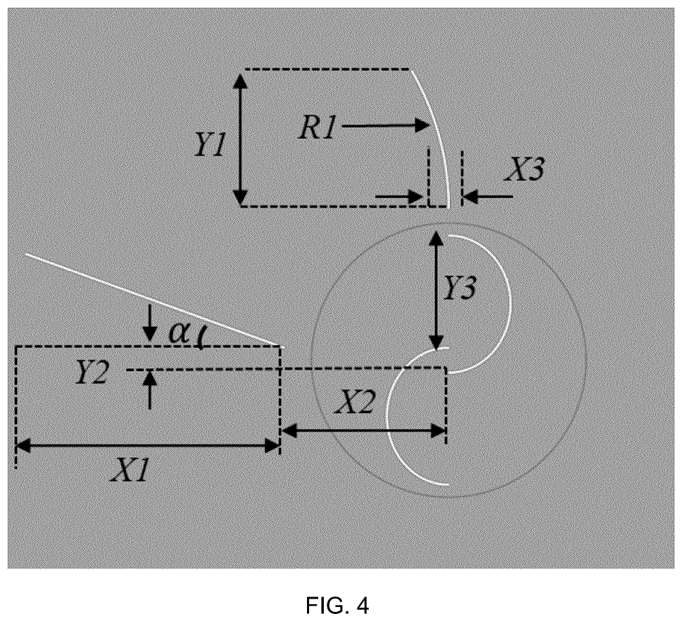

FIG. 3 illustrates geometric parameters of an elliptical-type VAWT.

For placing the turbine and guides in between opposite moving lanes, the geometry has to be duplicated at 180 degrees without intersecting each other or blocking any paths. Guides on each side can face opposite directions because traffic will be coming from opposite directions. Various parameters for examples of systems with two guides and three guides are illustrated in FIGS. 4 and 5. These include guide vane angles (a), radius of guide vanes (R), horizontal guide positions (X), and vertical guide positions (Y). Two guide parameters are defined in FIG. 4. Three guide parameters are defined in FIG. 5.

For two guide embodiments, X1 may be in a range of from about 0.1 to about 10 meters, including from about 0.2 to about 5 meters, from about 0.3 to about 3 meters, from about 0.5 to about 2 meters, from about 0.75 to about 1.25 meters, from about 0.9 to about 1.1 meters, and about 1.0 meter.

For two guide embodiments, X2 may be in a range of from about 0.1 to about 10 meters, including from about 0.2 to about 3 meters, from about 0.3 to about 2 meters, from about 0.4 to about 1 meters, from about 0.5 to about 0.7 meters, and about 0.6 meter.

For two guide embodiments, X3 may be in a range of from −2.0 to about 2.0 meters, including from about −1.0 to about 1.0 meters, from about −0.8 to about 0.8 meters, from about −0.7 to about 0.7 meters, from about −0.10 to about 0.10 meters, from about −0.05 to about 0.05 meters, and about 0.04545 or about −0.04545 meter.

For two guide embodiments, Y1 may be in a range of from about 0.1 to about 10 meters, including from about 0.2 to about 5 meters, from about 0.3 to about 2 meters, from about 0.4 to about 0.6 meters, and about 0.05 meter.

For two guide embodiments, Y2 may be in a range of from 0 to about 2.0 meters, including from about 0 to about 1.0 meters, from about 0 to about 0.8 meters, from about −0.001 to about 0.7 meters, from about 0.01 to about 0.10 meters, from about 0.02 to about 0.05 meters, and about 0 to about 0.04545 or about 0 to about −0.04545 meter.

For two guide embodiments, Y3 may be in a range of from about 0.1 to about 10 meters, including from about 0.2 to about 5 meters, from about 0.3 to about 2 meters, from about 0.4 to about 0.6 meters, and about 0.05 meter.

For two guide embodiments, a may be in a range of from about 0 to about 50°, including from about 1 to about 45°, from about from about 2 to about 40°, from about 3 to about 35°, from about 4 to about 30°, and about 0°.

For two guide embodiments, R1 may be in a range of from about 0.1 to about 10 meters, including from about 0.2 to about 5 meters, from about 0.3 to about 3 meters, from about 0.5 to about 2 meters, from about 0.75 to about 1.25 meters, from about 0.9 to about 1.1 meters, and about 1.0 meter.

For three guide embodiments, X1 may be in a range of from about 0.1 to about 10 meters, including from about 0.2 to about 5 meters, from about 0.3 to about 3 meters, from about 0.5 to about 2 meters, from about 0.75 to about 1.25 meters, from about 0.9 to about 1.1 meters, and about 1.0 meter.

For three guide embodiments, X2 may be in a range of from about 0.1 to about 10 meters, including from about 0.2 to about 3 meters, from about 0.3 to about 2 meters, from about 0.4 to about 1 meters, from about 0.5 to about 0.7 meters, and about 0.6 meter.

For two guide embodiments, X3 may be in a range of from −2.0 to about 2.0 meters, including from about −1.0 to about 1.0 meters, from about −0.8 to about 0.8 meters, from about −0.7 to about 0.7 meters, from about −0.10 to about 0.10 meters, from about −0.05 to about 0.05 meters, and about 0 to about 0.04545 or about −0.04545 meter.

For three guide embodiments, X4 may be in a range of from about 0.1 to about 10 meters, including from about 0.2 to about 5 meters, from about 0.3 to about 3 meters, from about 0.5 to about 2 meters, from about 0.75 to about 1.25 meters, from about 0.9 to about 1.1 meters, and about 1.0 meter.

For three guide embodiments, Y1 may be in a range of from about 0 to about 5 meters, including from about 0.01 to about 4 meters, from about 0.02 to about 3 meters, form about 0.03 to about 2 meters, from about 0.04 to about 1 meter, from about 0.05 to about 0.5 meters, from about 0.06 to about 0.4 meters, from about 0.07 to about 0.3 meters, from about 0.08 to about 0.2 meters, from about 0.09 to about 0.11 meters and about 0.10 meters.

For three guide embodiments, Y2 may be in a range of from about 0.1 to about 10 meters, including from about 0.2 to about 5 meters, from about 0.3 to about 2 meters, from about 0.4 to about 0.6 meters, and about 0.05 meter.

For three guide embodiments, Y3 may be in a range of from about 0 to about 5 meters, including from about 0.01 to about 4 meters, from about 0.02 to about 3 meters, form about 0.03 to about 2 meters, from about 0.04 to about 1 meter, from about 0.05 to about 0.5 meters, from about 0.06 to about 0.4 meters, from about 0.07 to about 0.3 meters, from about 0.08 to about 0.2 meters, from about 0.09 to about 0.11 meters and about 0.10 meters.

For three guide embodiments, a may be in a range of from about 10 to about 85°, including from about 20 to about 80°, from about from about 30 to about 75°, from about 45 to about 70°, and from about 50 to about 60°.

For three guide embodiments, R1 may be in a range of from about 0.01 to about 5 meters, including from about 0.02 to about 3 meters, from about 0.03 to about 2 meters, from about 0.4 to about 1 meter, from about 0.45 to about 0.65 meters, from about 0.5 to about 0.6 meters, and about 0.55 meters.

For three guide embodiments, R2 may be in a range of from about 0.1 to about 10 meters, including from about 0.2 to about 5 meters, from about 0.3 to about 3 meters, from about 0.5 to about 2 meters, from about 0.75 to about 1.25 meters, from about 0.9 to about 1.1 meters, and about 1.0 meter.

### Simulation Geometry

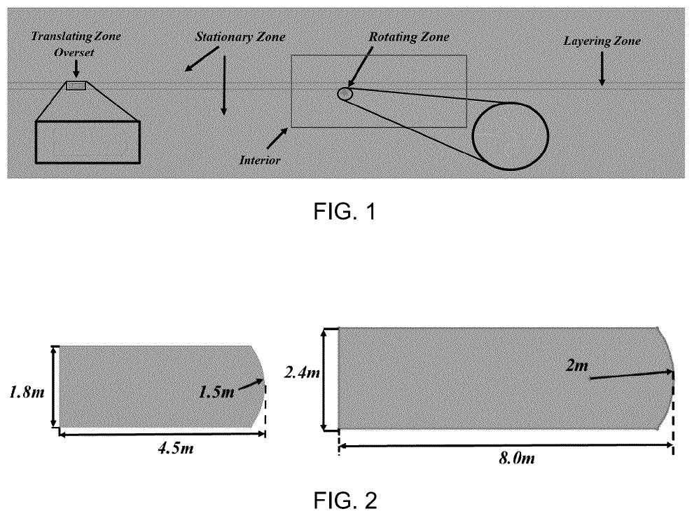

The computational domain geometry used in this study is shown in FIG. 1 illustrates a non-limiting example of computational domain geometry including two stationary zones, a layering zone, a rotating zone, and a translating zone.

Both passenger and large vehicle configurations are presented in FIG. 2 features dimensions outlined in references shown in the figure caption. The car geometry included a radius of 1.5 meters, a length of 4.5 meters, and a width of 1.8 meters. Conversely the bus geometry had a radius of 2 meters, a length of 6 meters, and a width of 2.4 meters.

In FIG. 3, the elliptical rotor configuration employed for the vertical axis wind turbine (VAWT) simulations is presented. The rotating zone included a 1.0-meter diameter circular domain that contains two elliptical blades with a large diameter of 0.5 meters and a small diameter of 0.225 meter. The circular domain rotates with the blades enabling the aerodynamic interactions between the wakes generated by vehicles and the turbine blades.

### Highway VAWT Using Two Guides

The geometry of the two-guide setup is shown in FIG. 4. The parameters available for adjustment are defined in FIG. 4.

This systematic parametric methodology facilitated a comprehensive exploration of how specific geometric variables impact the aerodynamic efficiency and energy generation of the turbine.

### Highway VAWT Using Three Guides

FIG. 5 displays the geometry of the three-guide setup. The parameters tested are defined in FIG. 5.

FIG. 27 is a chart highlighting the parameters that were changed in the design and their values alongside the remaining fixed geometric parameters for the two-guide setup.

FIG. 28 is a chart presenting the parameters for the three-guide setup again highlighting the parameters that were varied in the simulations.

It should be understood that each point value in these figures also discloses the specific value plus or minus 50%, plus or minus 40%, plus or minus 30%, plus or minus 20%, plus or minus 10%, plus or minus 5%, plus or minus 4%, plus or minus 3%, plus or minus 2%, and plus or minus 1%.

### Boundary Condition (BC)

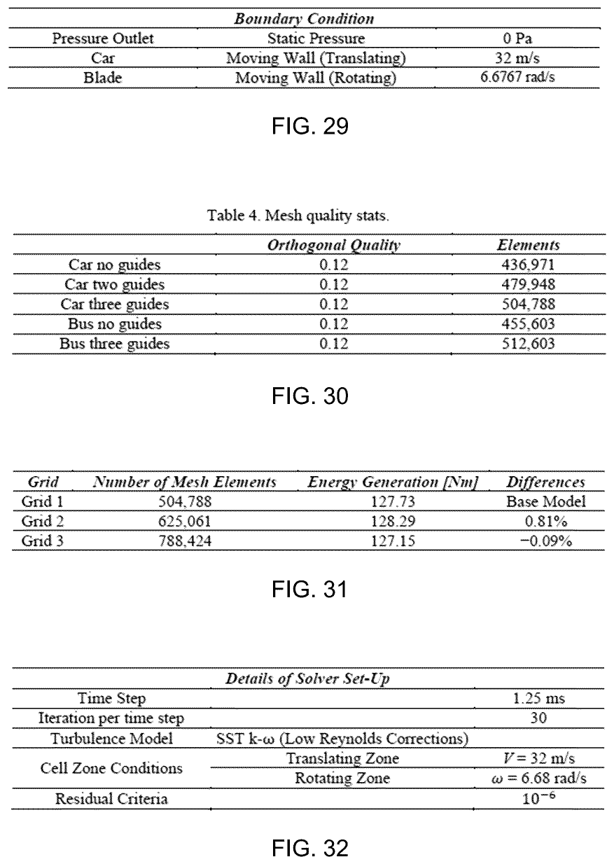

The elliptical VAWT installed along a highway, affected by traffic flow, is modeled using four main areas: layering, stationary, translating, and rotating. The left and right vertical boundaries were set to pressure outlet condition while the flow movement is generated by the speed of the car which is set up in the translating zone 32 m/s (71.58 mph). To integrate the translating zone with the background (layering zone), the overset method in ANSYS was used. The top and bottom boundaries were previously set to symmetry but changed to pressure outlet and the rotating zone was previously set up to rotate at 6 rad/s (57.3 RPM) but rotating speed was changed to 6.6767 rad/s (63.75 RPM). The car outline edges, and the turbine blade edges are set to walls. This zoning setup is the same for both car and bus simulations. FIG. 6 shows the 2D computational space and boundary conditions for the elliptical VAWT on the highway with a car. FIG. 29 is chart with boundary conditions.

### Meshing

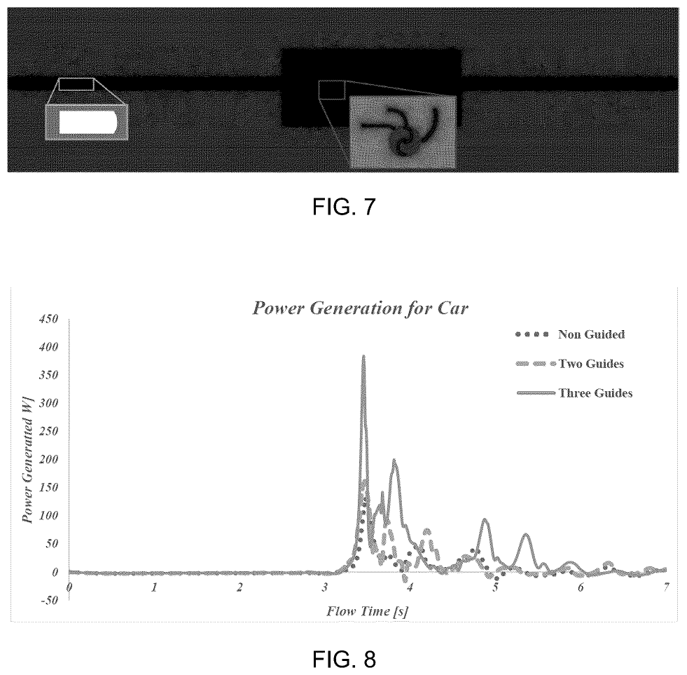

The computational mesh generation process adopted a consistent approach across all configurations, including the non-guided, two-guide, and three-guide scenarios. FIG. 7 visually represents the meshing strategy, providing a zoomed-in perspective of the critical areas surrounding the car geometry and turbine blade assembly.

FIG. 30 is a chart summarizing the mesh quality metrics, detailing the number of elements employed for the car and bus geometries across the non-guided, two-guide, and three-guide setups. This table reports satisfactory orthogonal quality values, indicating the suitability of the generated meshes for the computational simulations.

FIG. 31 is a chart illustrating grid convergence.

### Set-Up

All simulations were set to transient, and the viscous model used was SST k-w turbulence model with Low-Reynolds number corrections.

To oversee the complex interactions between the different zones, the simulation employed the overset and dynamic mesh methods. The overset method allowed for the combination of the layering and translating zones, enabling the integration of the different mesh regions.

The rotating zone had a mesh motion model with an angular velocity of 6 rad/s. Similarly, the translating zone utilized a mesh motion setup with a translational velocity of 32 m/s. The car and the turbine blades were both set up as moving walls, with the car in translational motion and the blades in rotational motion.

The dynamic mesh approach was employed, with the layering mesh method selected as the option. The SixDegrees of Freedom (6DoF) feature was used, and the turbine was modeled as a single-degree-of-freedom rotational component.

The pressure, momentum, turbulent kinetic energy, and specific dissipation rate were discretized using a second-order upwind scheme, while the transient formulation employed a second-order implicit method. The residual convergence criteria were set to 1e-6.

The layering zone had a mesh cell height of 0.1 meters. The maximum time step was calculated as 1.953125×10⁻³ s, allowing us to accurately track the car's position when its front end reached −2 m from the center of the turbine. This is the point where the turbine produced its peak torque; however, a finer time step of 1.25×10⁻³ s was selected to enhance stability and accuracy. Time step used was 0.00125 s. The model was simulated for a total duration of 7 seconds, with a maximum of 30 iterations per time step.

### Results

Various guide configurations have been investigated, consistently revealing that three-guide designs provide the most efficient solution for maximizing energy generation in the presence of passing vehicles.

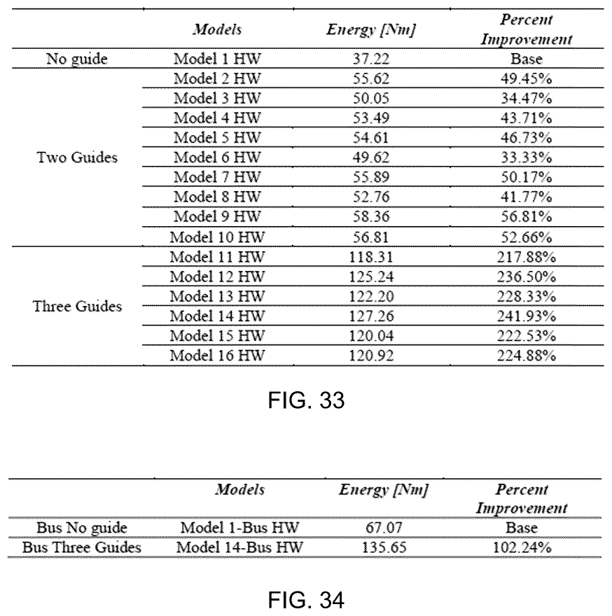

FIG. 33 represents the extensive numerical testing conducted on the highway VAWT. A total of nine two-guide models and five three-guide models, along with the non-guided configuration, were assessed. Across all scenarios, a consistent trend emerged: the three-guide VAWT designs outperformed the two-guide designs, which, in turn, surpassed the non-guided setup for the car model. Additionally, Model 1-Bus HW and Model 14-Bus HW, as depicted in FIG. 34, showcased significant energy generation improvements even for bigger vehicles as a bus when using of the exact same three guide design as in Model 14 with a car.

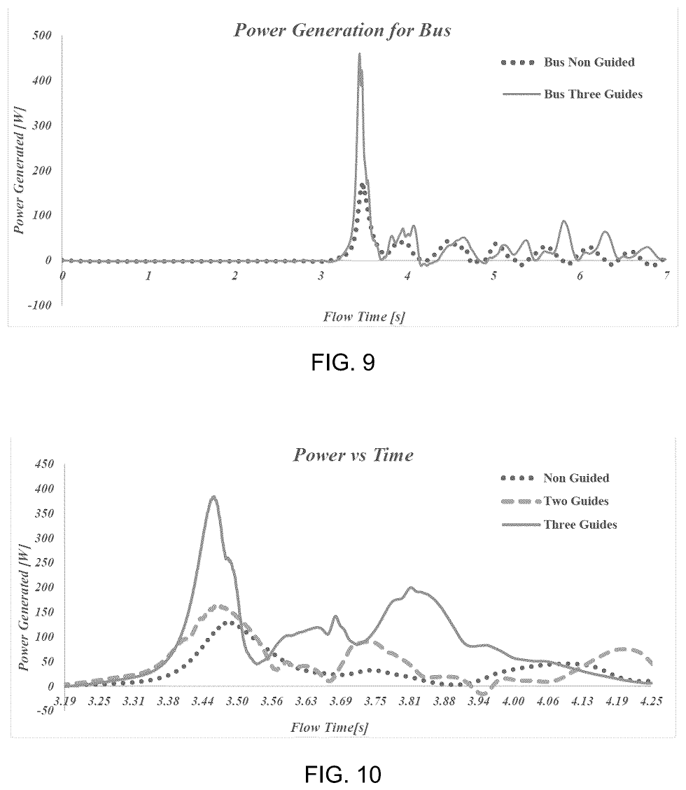

FIGS. 8 and 9 show the power generation as a function of time for both the car and the bus vehicles. No power is generated until the after more than three seconds which represents the time it takes the vehicle to travel from the initial position 110 meter ahead of the wind turbine to about 7 meter in front of the turbine. The power generation fluctuates around the zero-power line after the vehicle has past the turbine suggesting that there is still vehicle generated vortices present around the turbine, but they will not add any significant energy generation. Thus, the usable flow lasts under one second for a vehicle traveling at 32 m/s.

The VAWT begins generating torque as the vehicle approaches the 8 meter mark in front of the turbine, and at the 3.18755 second mark. The peak energy generation is observed at the 3.4 seconds point for the car and 3.36 seconds for the bus which corresponds to a vehicle position of 1 to 2.5 meters in front of the turbine. There are two more power generation peaks for both car and bus at slightly different times. The noticeable difference is that the bus model maintains a more even power generation over time while the car model shows distinct peaks with almost zero power captured in between. A notable observation is that the two-guide model show two power peaks while the three-guides models show three power peaks. This fluctuating power generation could be improved by changing the number of blades on the turbine and by optimizing the guide geometry. The guides are able to help the turbine capture residual vortices after the vehicles have drove past the turbine around 20 meters while the non-guided configurations (car and bus) significantly drop the energy generation after the 6-meter past turbine vehicle position.

The superior performance of the three-guide designs can be attributed to their enhanced ability to manage and optimize the wind flow from passing vehicles and capture additional flow vortices after the car passed the turbine. The additional third guide is directly responsible for the additional vortices being captured.

It also helps channel, concentrate, and direct the airflow more effectively towards the VAWT blades, resulting in higher wind energy capture. Furthermore, the multiple guides work together to continually capture the wind generated by the vehicle as it moves past the turbine and the flow changes direction. In contrast, the Non-guided VAWT lacks this wind flow management capability, leading to lower energy production compared to guide-equipped designs.

These findings clearly demonstrate the benefits of incorporating strategic guide placements around VAWT installations along highways.

The performance of a VAWT is evaluated based on the amount of energy (E) it can produce during a single pass of a vehicle. This energy value is calculated using Equations 1 and 2, expressed in Watt-seconds, by finding the area under the instantaneous power (Pᵢₙₛ) versus time (t) curve using the trapezoidal rule.

The instantaneous power is Pᵢₙₛ, the instantaneous torque is tᵢₙₛ, and the instantaneous rotor velocity is ωᵢₙₛ. This represents the power output of the VAWT at a given point in time during the vehicle pass.

$$\begin{matrix}{\sum }_{0}^{n - 1} ( {P}_{i n {s}_{i + 1}} + {P}_{i n {s}_{i}} ) ( {t}_{i + 1} - {t}_{i} ) \\ {P}_{i n s} = {T}_{i n s} * {ω}_{i n s}\end{matrix}$$

The computational simulations provided insightful visualizations of the velocity field around the elliptical highway-mounted vertical axis wind turbine (VAWT).

The figures illustrate the velocity contours two, four, six, and eight meters downstream from the turbine after the vehicle's passage, contrasting the non-guided and three-guide vane configurations. The three-guide vane scenario exhibited larger velocity magnitudes in regions around the turbine blades compared to the non-guided case. The advancing blade (lower right blade) displayed higher velocity magnitudes on its backside.

At 6 meters downstream from the turbine, a significant concentration of high-velocity flows around the turbine blades can be seen, with velocity magnitudes reaching 22 m/s. This magnitude is 60% larger than for the non-guide configuration showing that the guides are accelerating the flow around the turbine blades. The presence of these elevated velocity zones on the advancing blades of the turbine will enhance the aerodynamic forces contributing to improved torque generation.

Velocity vectors colored by velocity magnitude are shown in the figures, both for non-guided and three-guided configurations at two, four, six, and eight meters downstream from the turbine after the vehicle's passage. The non-guided setup doesn't exhibit the high velocity areas that the three-guided one does, and the vectors interact with both advancing and returning blades. The three-guided setup, at two meters downstream from the turbine, the velocity vectors form a noticeable different pattern. The velocity vectors are not impinging straight into the returning blade (blade on top-left) but are guided alongside the returning blade. This reduces the negative torque generation. A higher concentration of velocity vectors striking the advancing blade (lower right blade) is visible at all car positions. Additionally, the guides generate larger velocity magnitudes around the backside of the advancing blade which produces lower pressures and thus creating suction that increases the torques. This suggests an increased interaction between the vehicle's wake and the rotor when using guides. The vehicle distances of six meters and eight meters downstream further emphasize the guide vanes' impact on the velocity vector field. These flow visualizations reveal a more complex and beneficial velocity vector field acting on the turbine blades compared to the non-guided setup.

The velocity contours for the bus configuration using the non-guide and the same three-guide vanes as in the car models are illustrated in the figures. The three-guided setup showed up to 25% higher velocity values around the turbine blades than the non-guided setup which is less than in the case of the car models. This explains the lower improvement in energy generation for the bus model of 228% versus 325% for the car models when using the three guides configuration as seen in FIG. 32 and FIG. 33.

The velocity vectors for two, four, six, and eight meters downstream from the turbine after the vehicle's passage are illustrated in the figures. The bus models show the same beneficial velocity vector field acting on the turbine blades on the three-guide configuration compared to the non-guided setup.

### CONCLUSION

The simulations explored ways to improve the efficiency of small-scale vertical axis wind turbines (VAWTs) installed alongside highways to generate clean energy. The proposed method involves using strategically positioned guide vanes to capture wind energy from passing vehicles, which can be used to produce electricity and/or clean hydrogen.

The results show a significant increase in energy output when using a multi-guide vane setup compared to a standalone VAWT. An elliptical VAWT design was selected for its superior performance over a Savonius type, generating a baseline energy output of 16.11 Nm under simulated highway conditions (vehicle speed of 32 m/s, 71.6 mph) using CFD modeling.

By introducing two guide vanes—a flat and a curved design—adjusted through adjustments in orientation and geometry, the energy output increased significantly to 49.62 to 58.36 Nm, representing a 33.33 to 56.81% improvement. Further adjustments with a three-guide vane setup achieved an even greater enhancement, reaching a peak energy output of 118.31 to 127.26 Nm, a remarkable 217.88 to 241.93% improvement over the unguided scenario.

The effectiveness of the multi-guide vane system was confirmed by simulating the VAWT's exposure to the wake flow generated by a bus traveling at highway speeds (71.6 mph). Compared to the unguided bus configuration's output of 67.07 Nm, the three-guide vane setup with a bus yielded a substantial increase to 135.65 Nm, translating to a 102.24% enhancement in energy capture.

In conclusion, the simulations demonstrate the potential of strategically placed multi-guide vanes along with an elliptical VAWT design to significantly improve energy extraction from highway traffic. This technology presents a promising opportunity for harnessing renewable wind energy for clean electricity generation and hydrogen production, contributing to a more sustainable transportation future.

### Potential Future Work

Moving forward, it would be beneficial to carry out 3D computational fluid dynamics (CFD) simulations and experimental validation of the proposed wind energy harvesting system. While the 2D CFD models have offered valuable insights and optimization for the wind turbine and guide configurations, 3D simulations would better capture the intricate flow patterns and turbulence effects that impact the system's performance. Additionally, constructing and testing a physical prototype in either a controlled wind tunnel or field setting would validate the numerical predictions and provide real-world performance data. This combination of 3D simulation and experimental work would enhance the understanding of this technology and instill confidence in its practical implementation along highways. By incorporating these additional research endeavors, the project can deliver a more thorough evaluation of the proposed system, bridging the gap between computational models and actual hardware performance, ultimately resulting in a more robust and dependable technology for deployment.

This study focuses on optimizing vertical axis wind turbine (VAWT) systems to harness energy from winds induced by vehicles driving on highways. The goal is to improve the efficiency of small-scale VAWTs mounted along highways for electricity generation or clean hydrogen production.

In summary, by introducing a single flat or curved guide near the turbine, power output increased 33.33 to 56.81% for wind generated by passenger vehicles (car). Further enhancements, including using three guides with optimized shape, led to a more remarkable 217.88 to 241.93% improvement. Computational Fluid Dynamics (CFD) simulations for large vehicles (bus) driving on highways also showed a significant increase in energy capture of 102% for the three-guide vane configuration versus non-guided setups. This demonstrates the positive impact of optimized guide vanes on VAWT aerodynamics. These findings highlight the potential of vehicle-induced highway winds as a renewable energy source.

All comparison simulations consider the turbine without guides and the turbine with guides to have the exact same position with respect to the passing vehicle.

If the turbine with guides is compared to a turbine without guides that is positioned closer to the passing vehicle so that the distance between the outmost surface of the turbine and the vehicle is matching the distance between the outmost surface of the guides and the vehicle, then the percent improvement of our design is 33% which is still significant and it does not require to have rotating equipment close to passing vehicles on the highway.

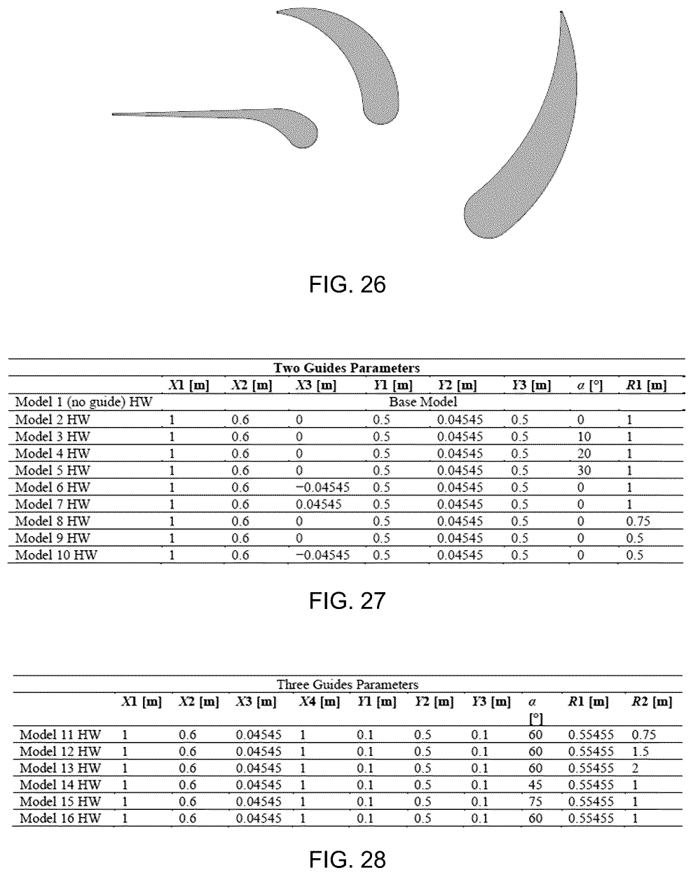

FIG. 26 illustrates non-limiting examples of guide designs. The guides are not required to be of uniform thickness. There are advantages to having increasing thickness in the direction of the flow.

FIG. 1 illustrates 2D computational domain (CD) for an elliptical vertical axis wind turbine (VAWT) on a highway with a car. For the area is the rectangle, finer structure mesh was used for CD analysis. FIG. 2 illustrates geometric dimensions of a car (left) and a bus (right). FIG. 3 illustrates geometric parameters of an elliptical-type VAWT. FIG. 4 illustrates geometric parameters of a highway VAWT using two guides.

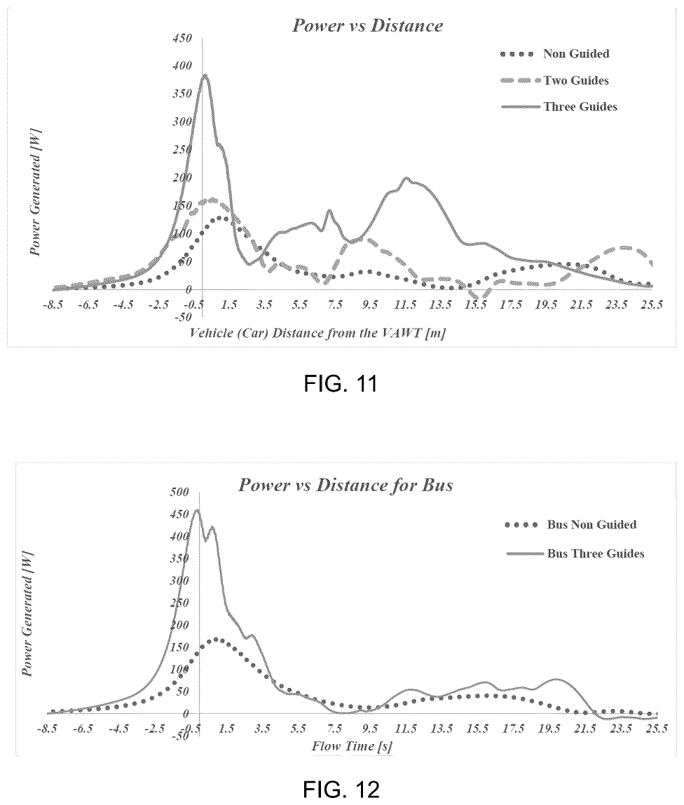

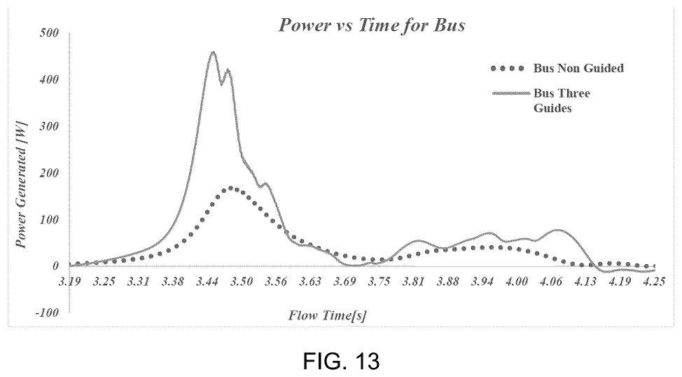

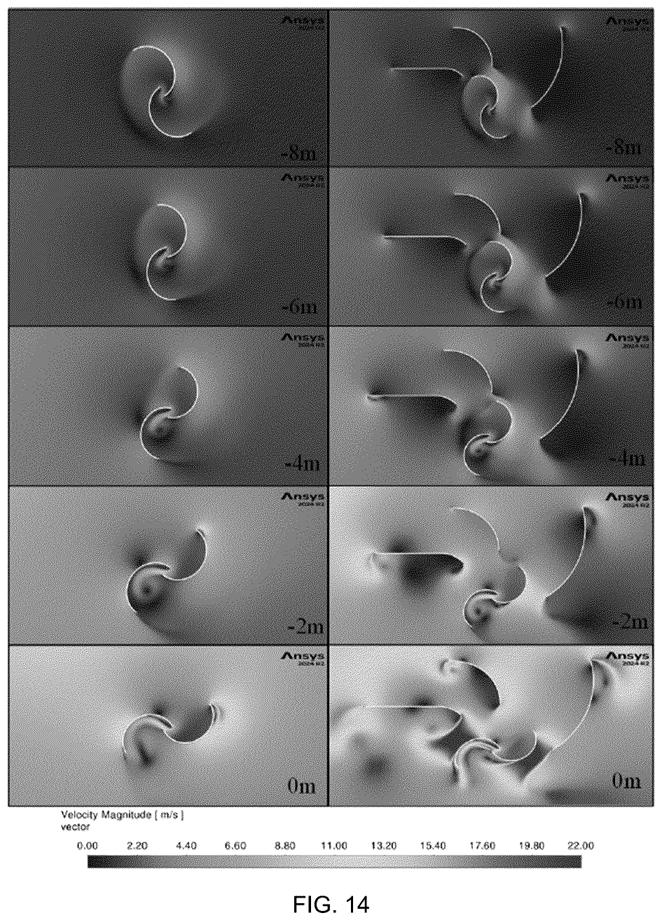

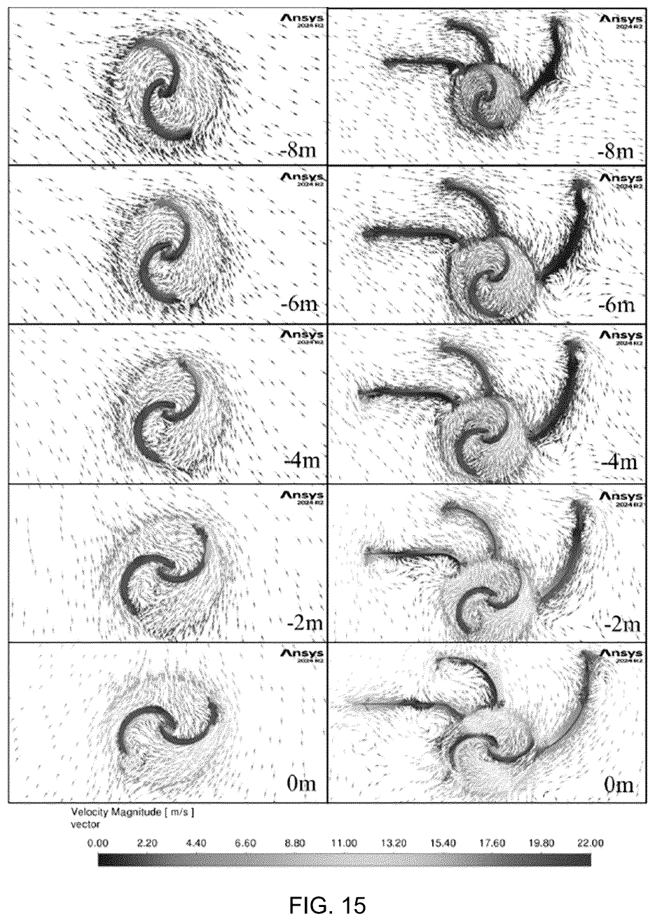

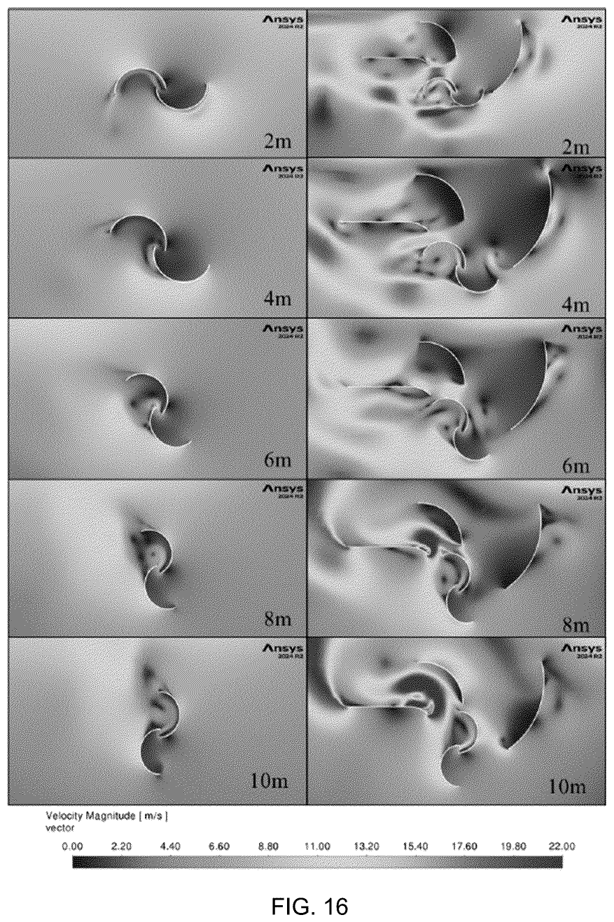

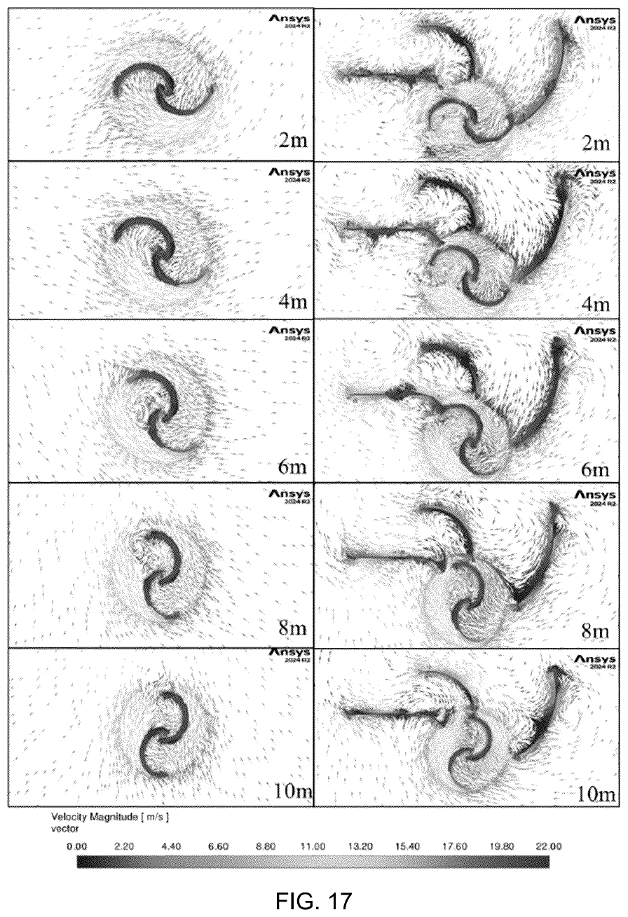

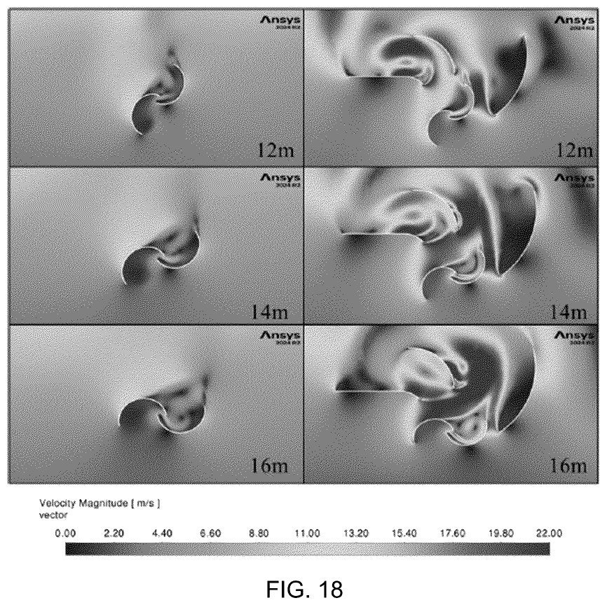

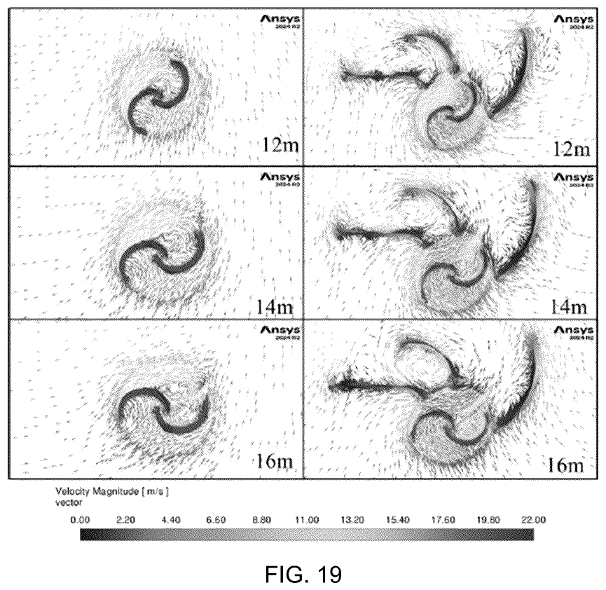

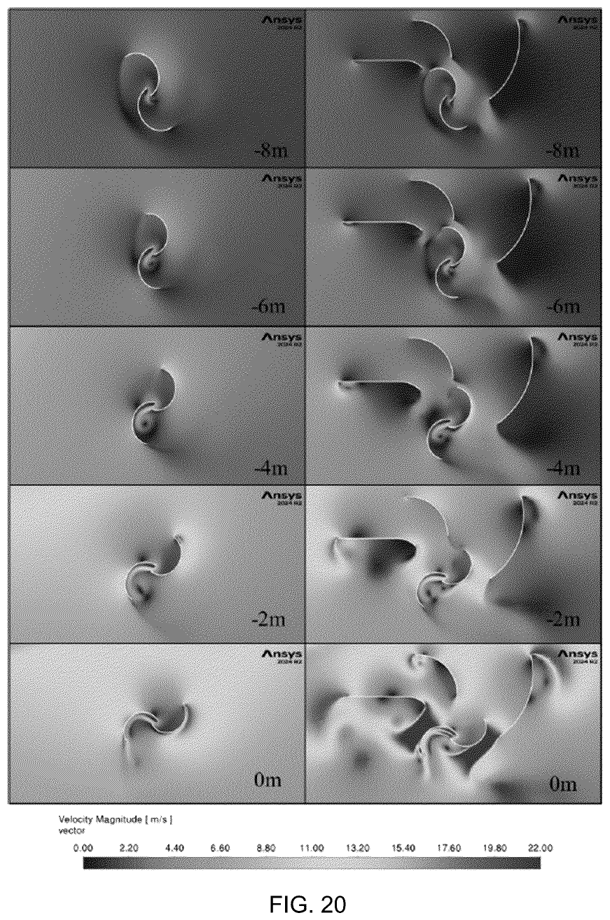

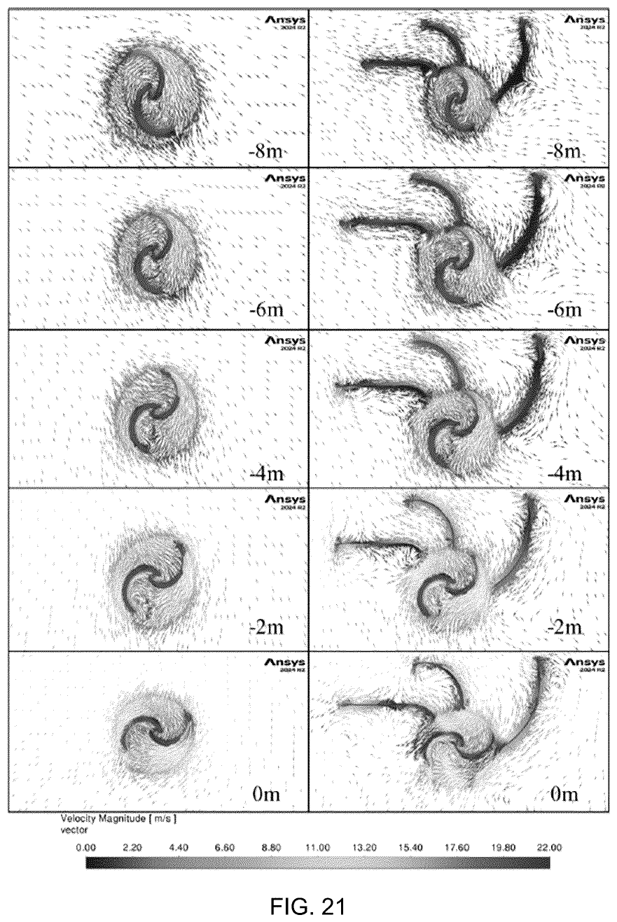

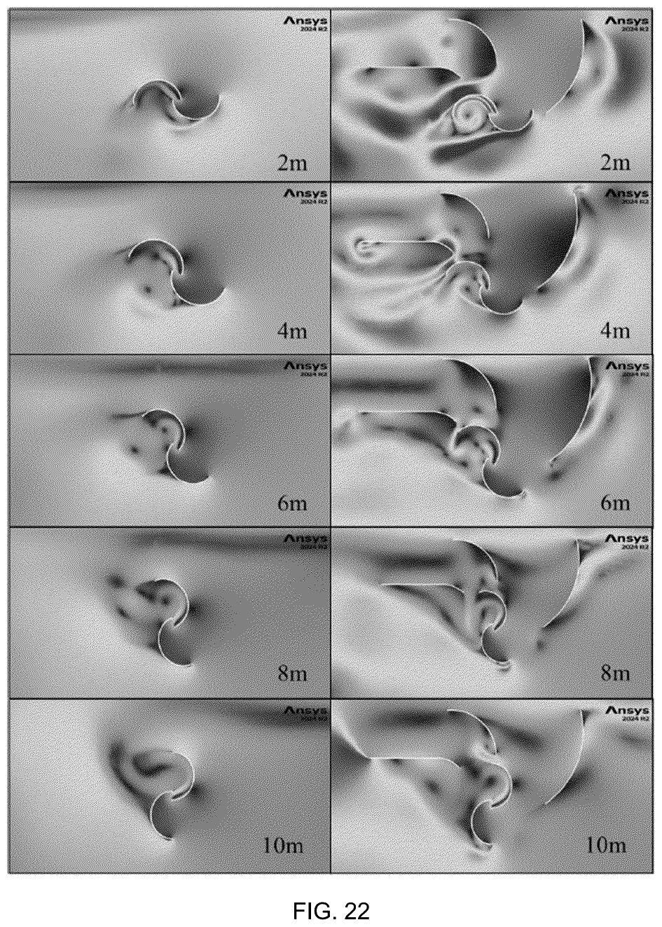

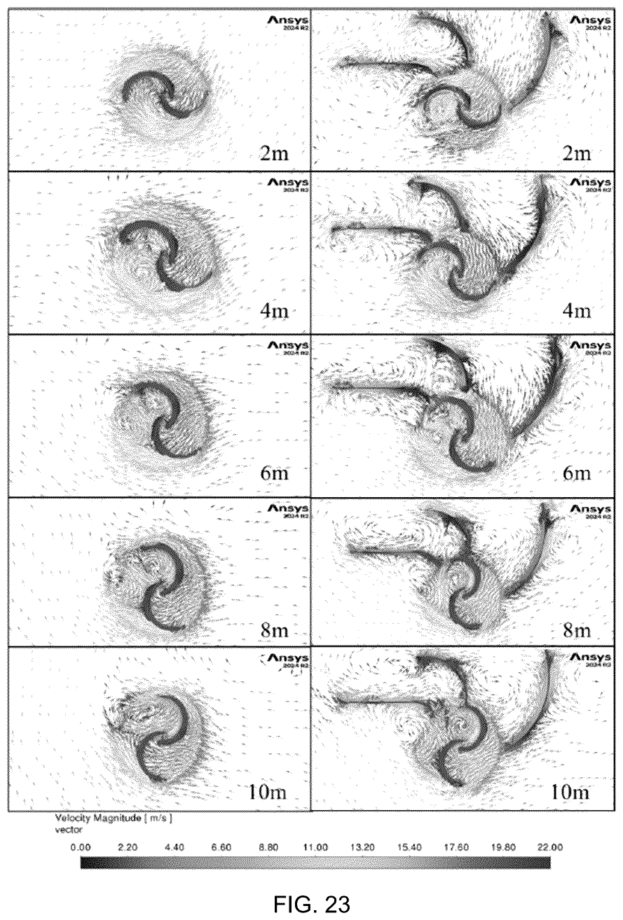

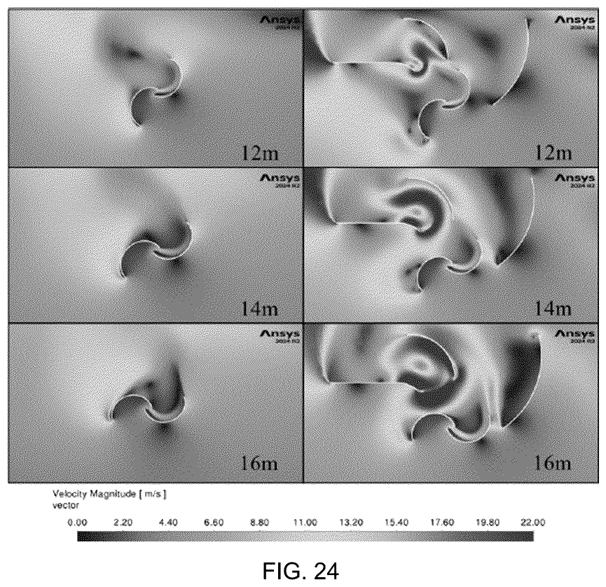

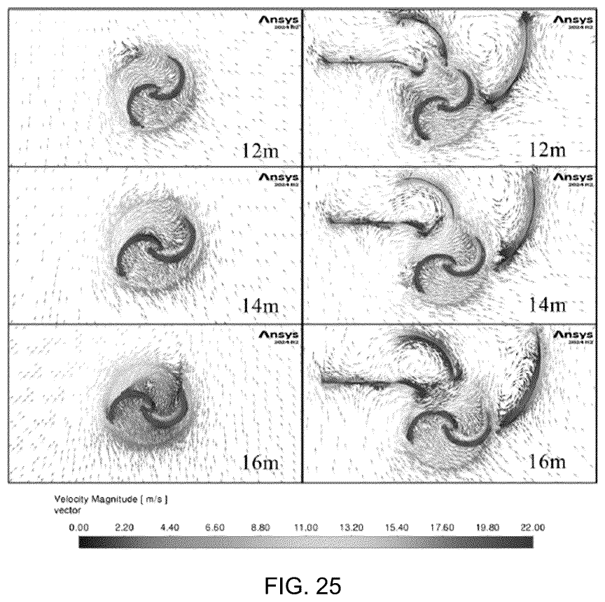

FIG. 5 illustrates geometric parameters of a highway VAWT using three guides. FIG. 6 illustrates 2D boundary conditions for an elliptical VAWT on a highway with a car. For the area is the rectangle, finer structure mesh was used for CD analysis. FIG. 7 illustrates details of the computational mesh for a three-guide system on a highway using a car. FIG. 8 illustrates power generation for a car over flow time for unguided, two guide, and three guide embodiments. FIG. 9 illustrates power generation for a bus over flow time for unguided, two guide, and three guide embodiments. FIG. 10 illustrates power generation for a car (detail) over flow time for unguided, two guide, and three guide embodiments. FIG. 11 illustrates power versus car distance from the VAWT. FIG. 12 illustrates power versus bus distance from the VAWT. FIG. 13 illustrates power generation for a bus (detail) over flow time for unguided, two guide, and three guide embodiments. FIG. 14 illustrates velocity distribution for a car for a VAWT for non-guided (left) and three-guides (right) configurations. FIG. 15 illustrates velocity vectors for a car for non-guided (left) and three-guides (right) configurations. FIG. 16 illustrates velocity distribution for a car for a VAWT for non-guided (left) and three-guides (right) configurations. FIG. 17 illustrates velocity vectors for a car for non-guided (left) and three-guides (right) configurations. FIG. 18 illustrates velocity distribution for a car for a VAWT for non-guided (left) and three-guides (right) configurations. FIG. 19 illustrates velocity vectors for a car for non-guided (left) and three-guides (right) configurations. FIG. 20 illustrates velocity distribution for a bus for a VAWT for non-guided (left) and three-guides (right) configurations. FIG. 21 illustrates velocity vectors for a bus for non-guided (left) and three-guides (right) configurations. FIG. 22 illustrates velocity distribution for a bus for a VAWT for non-guided (left) and three-guides (right) configurations. FIG. 23 illustrates velocity vectors for a bus for non-guided (left) and three-guides (right) configurations. FIG. 24 illustrates velocity distribution for a bus for a VAWT for non-guided (left) and three-guides (right) configurations. FIG. 25 illustrates velocity vectors for a bus for non-guided (left) and three-guides (right) configurations. FIG. 26 illustrates non-limiting examples of guide designs. FIG. 27 is a chart including parameters for two guides. FIG. 28 is a chart including parameters for three guides. FIG. 29 is a chart providing boundary conditions. FIG. 30 is a chart providing mesh quality stats. FIG. 31 is a chart providing grid convergence information. FIG. 32 is a chart providing the solver set-up. FIG. 33 is a chart for energy and improvement information for no guide, two guides, and three guides for a single car on a highway. FIG. 34 is a chart for energy and improvement information for no guide and three guides for a single bus on a highway.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A vertical axis wind turbine system comprising:
a vertical axis wind turbine; and
a plurality of guides configured to guide wind to the vertical axis wind turbine;
wherein the system is configured to capture more of generated winds even after a vehicle has passed the turbine.

2. The system of claim 1, wherein the plurality of guides comprises two or more guides.

3. The system of claim 1, wherein the vertical axis wind turbine system comprises three or more guides.

4. The system of claim 1, wherein the vertical axis wind turbine system comprises three guides.

5. The system of claim 1, wherein the vertical axis wind turbine system comprises four guides.

6. The system of claim 1, wherein the plurality of guides consists of two guides.

7. The system of claim 6, wherein X3 is in a range of from about −2.0 to about 2.0 meters.

8. The system of claim 6, wherein X3 is in a range of from about −1.0 to about 1.0 meters.

9. The system of claim 6, wherein is in a range of from about −0.04545 to about 0.4545 meters.

10. The system of claim 6, wherein a is in a range of from about 0 to about 40°.

11. The system of claim 6, wherein a is in a range of from about 10 to about 30°.

12. The system of claim 6, wherein a is about 0°.

13. The system of claim 1, wherein the plurality of guides consists of three guides.

14. The system of claim 13, wherein R2 is in a range of from about 0.3 to about 3.0 meters.

15. The system of claim 13, wherein R2 is in a range of from about 0.5 to about 2.0 meters.

16. The system of claim 13, wherein R2 is in a range of from about 0.75 to about 1.25 meters.

17. The system of claim 13, wherein a is in a range of from about 30 to about 75°.

18. The system of claim 13, wherein a is in a range of from about 45 to about 70°.

19. The system of claim 13, wherein a is in a range of from about 50 to about 60°.

20. A method for generating electricity comprising:
passing a vehicle through the system of claim 1.
